(19) United States
(12) Patent Application Publication
(10) Pub. No.: US 2005/0136940 A1
(43) Pub. Date: Jun. 23, 2005

(54) Method of setting monitoring period for paging channel

(75) Inventor: Ki-Chul An, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 11/003,500

(22) Filed: Dec. 6, 2004

(30) Foreign Application Priority Data
Dec. 17, 2003 (KR) 10-2003-0092420

(51) Int. Cl. H04Q 7/20

(52) U.S. Cl. 455/455; 455/574

(57) ABSTRACT

Disclosed is a method of variably setting a monitoring period for a paging channel, the method including the steps of accumulating the number of calls occurred within each time range, setting the monitoring period for the paging channel to be long as the number of calls occurred within each time range becomes small, and monitoring the paging channel in every monitoring period set for each time range. In accordance with the present invention, it is possible to reduce battery power consumption in a mobile communication terminal.

### BACKGROUND OF THE INVENTION

This application claims the priority of Korean Patent Application No. 2003-92420, filed on Dec. 17, 2003, in the Korean Intellectual Property Office, the disclosure of which is incorporated herein in its entirety by reference.

1. Field of the Invention

The present invention relates to a mobile communication technology and, more particularly, to a method of variably setting a monitoring period for a paging channel in mobile communication terminals.

2. Description of Related Art

A spread spectrum communication system, such as a code division multiple access (CDMA) cellular mobile communication system, typically divides an entire service area into contiguous small zones called cells. Each cell contains a base station that communicates with mobile communication terminals in that cell, both for control purposes and for a call relay. The base station often transmits a pilot signal for purposes of synchronization and channel acquisition. All base stations have high-bandwidth connections to a mobile switching center (MSC), which is connected to a fixed network infrastructure. The base stations can be identified by their uniquely assigned pseudo-random noise (PN) spreading codes.

In the CDMA system, each of the base stations uses a traffic channel, a pilot channel, a synchronous channel, and a paging channel for voice or data communications. The pilot channel is used for unmodulated, direct sequence spread spectrum signals transmitted by the base station. The pilot channel is spread with Walsh 0 and allows a mobile communication terminal to acquire the timing of the CDMA channel. Further, the pilot channel provides a phase reference for coherent demodulation in addition to providing a means for comparing the signal strength between base stations to determine when to handoff. In particular, the mobile communication terminal determines, using pilot symbols acquired over the pilot channel, which of paging channels received from neighboring base stations is to be demodulated.

A brief description will now be given of a typical process of monitoring paging channel slots in the mobile communication terminal. First, the mobile communication terminal in its operating state acquires, through a radio frequency (RF) module, pilot symbols over the pilot channel from the base station. Once the pilot symbols are acquired, the mobile communication terminal synchronizes with the base station for time alignment purposes. Subsequently, the mobile communication terminal monitors the paging channel in either continuous or slotted mode to determine whether or not any paging signals are present in the paging channel.

When no paging signals are present in the paging channel, the mobile communication terminal determines whether or not any paging signals are present in other paging channels. When no paging signals are present in the paging channels or when the paging signals are completely processed, the mobile communication terminal comes to an idle state and then disconnects power supplied to the RF module.

In the CDMA mobile communication terminal, the paging channel typically operates in the slotted mode during the time interval when the mobile communication terminal is not in communication with the base station. During the slotted mode, a unique time slot is assigned to each of the mobile communication terminals, so that the mobile communication terminal operates only in predetermined slots to monitor the paging channel of the base station and comes to an idle state in the remaining slots. Here, the purpose of having the slotted mode is to allow the mobile communication terminal to power-down some of its receiver circuitry to conserve battery power.

FIG. 1 shows paging channel slots in the CDMA system. The paging channel comprises 16 periodically repeating slots, each slot having a duration of 80 ms. In the CDMA system, the duration of 80 ms corresponds to three times the rollover period (i.e., 26.667 ms) of a PN generator, or four times the frame time duration (i.e., 20 ms). Each of the paging channel slots has 64 pilot channel groups (PCGs) each having 18 pilot symbols.

Each of the mobile communication terminals is assigned a predetermined slot from the 16 paging channel slots. In this case, the mobile communication terminal operates to monitor a corresponding paging channel before reaching its assigned slot. The mobile communication terminal operates in an idle state in other paging channel slots.

Consequently, there has been a problem in that the battery power consumption cannot be significantly reduced in the conventional mobile communication terminal since it monitors paging channel slots at regular intervals without taking into account the number of calls occurred within each time range.

Accordingly, the battery power will be conserved if the monitoring periods are varied according to the number of call occurrences.

### SUMMARY OF THE INVENTION

The present invention provides a method of variably setting a monitoring period for a paging channel according to a call history to reduce battery power consumption in a mobile communication terminal.

The present invention also provides a method of automatically varying a monitoring period for a paging channel based on the number of call occurrences in a mobile communication terminal to reduce battery power consumption.

The present invention also provides a method of automatically and variably setting a monitoring period for a paging channel under the control of a base station without a user's intervention.

In accordance with an aspect of the present invention, there is provided a method of setting a monitoring period for a channel in a mobile communication terminal, the method comprising the steps of: obtaining a call history; varying the monitoring period according to the call history; and monitoring the channel according to the varied monitoring period.

The monitoring period may be a period of monitoring a paging channel.

The step of obtaining may comprise the step of accumulating the number of calls occurred within each time range.

The step of varying may comprise the step of setting the monitoring period for the paging channel to be long as the number of calls occurred within each time range becomes small.

In accordance with another aspect of the present invention, there is provided a method of setting a monitoring period for a channel in a mobile communication terminal, the method comprising the steps of: transmitting a message indicating a variable monitoring period from a base station to the mobile communication terminal; and changing an existing monitoring period with a monitoring period included in the message in the mobile communication terminal.

The monitoring period may be increased or decreased in step units according to the message.

The variable monitoring period may depend on a time it takes to receive a paging response message from the mobile communication terminal.

In accordance with another aspect of the present invention, there is provided a method of setting a monitoring period for a paging channel in a mobile communication terminal, the method comprising the steps of: accumulating the number of calls occurred within each time range; setting the monitoring period for the paging channel to be long as the number of calls occurred within each time range becomes small; and monitoring the paging channel at every monitoring period set for each time range.

The monitoring periods based on the time range may be set differently according to a day of the week.

The monitoring periods based on the time range may be set differently at every predetermined time interval within a preset time range.

In accordance with another aspect of the present invention, there is provided a method of setting a monitoring period for a paging channel in a mobile communication terminal, the method comprising the steps of: setting a power save mode in response to a user command; accumulating the number of calls occurred within each time range in the power save mode; setting the monitoring period for the paging channel to be long in the power save mode as the number of calls occurred within each time range becomes small; and monitoring the paging channel in the power save mode at every monitoring period set for each time range.

The method may further comprise the steps of: releasing the power save mode in response to a user command; and setting the monitoring period to a default value.

In accordance with another aspect of the present invention, there is provided a method of setting a monitoring period for a paging channel in a mobile communication terminal transmitting a paging response message in response to a paging signal, the method comprising the steps of: receiving a variable message which is used for varying the monitoring period from a base station responding to the transmitted paging response message; varying a preset monitoring period according to the received variable message; transmitting to the base station a response message in response to the received variable message; and monitoring the paging channel in the varied monitoring period.

The monitoring period may be increased or decreased in step units according to code information included in the variable message.

In accordance with another aspect of the present invention, there is provided a method of setting a monitoring period for a paging channel in a mobile communication terminal, the method comprising the steps of: measuring idle-state time of the mobile communication terminal; varying the monitoring period when the measured idle-state time exceeds a preset time length; and monitoring the paging channel in the varied monitoring period.

In accordance with another aspect of the present invention, there is provided a method of setting a monitoring period for a paging channel in a mobile communication terminal, the method comprising the steps of: measuring idle-state time of the mobile communication terminal; varying the monitoring period each time the measured idle-state time exceeds each of preset time lengths; and monitoring the paging channel in the varied monitoring period.

The monitoring period may be reset to a default value when the idle-state time exceeds the sum total of the preset time lengths.

The preset time lengths may be set to decrease sequentially.

### BRIEF DESCRIPTION OF THE DRAWINGS

The above and other features and advantages of the present invention will become more apparent by describing in detail exemplary embodiments thereof with reference to the attached drawings in which:

FIG. 1 shows paging channel slots in a CDMA system;

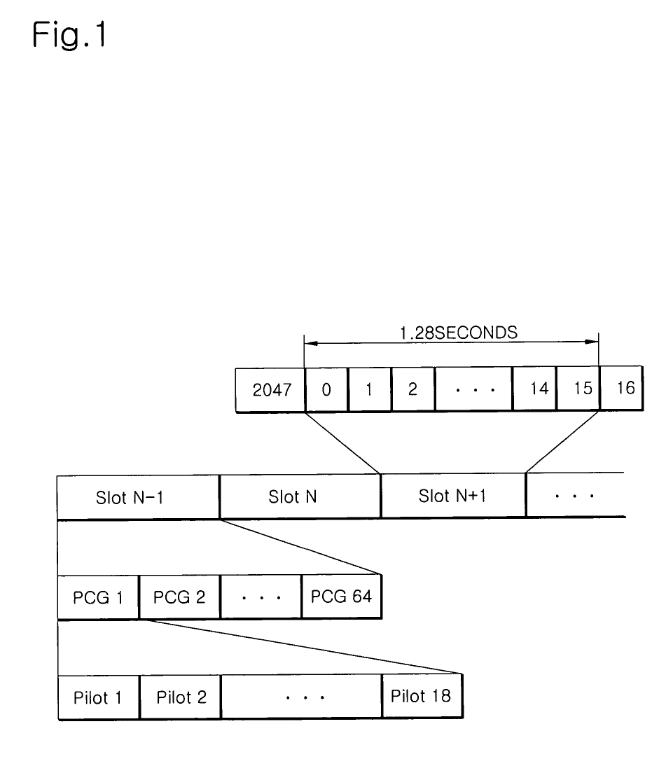

FIG. 2 is a block diagram showing a mobile communication terminal being implemented with a method according to the present invention;

FIG. 3 is a flowchart showing a process of setting a monitoring period for a paging channel in accordance with an embodiment of the present invention; and

FIG. 4 is a flowchart showing the process of setting a monitoring period for a paging channel in accordance with another embodiment of the present invention.

### DETAILED DESCRIPTION OF THE INVENTION

Exemplary embodiments in accordance with the present invention will be described in detail with reference to the accompanying drawings. In the following description, a detailed description will be omitted of well-known functions or configurations incorporated herein in the case when the description makes unclear the subject matter of the present invention.

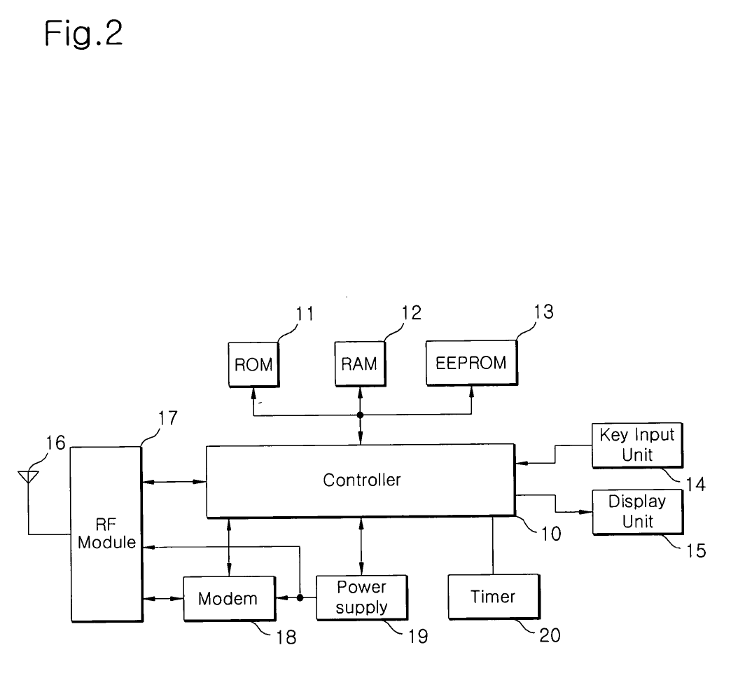

FIG. 2 is a block diagram showing a mobile communication terminal being implemented with a method according to the present invention.

A controller 10 is responsible for the overall operation of a mobile communication terminal. For example, the controller 10 counts and accumulates the number of calls occurred within each time range. A monitoring period for slots in a paging channel is set to be long by the controller 10 as the number of call occurrences becomes increasingly small.

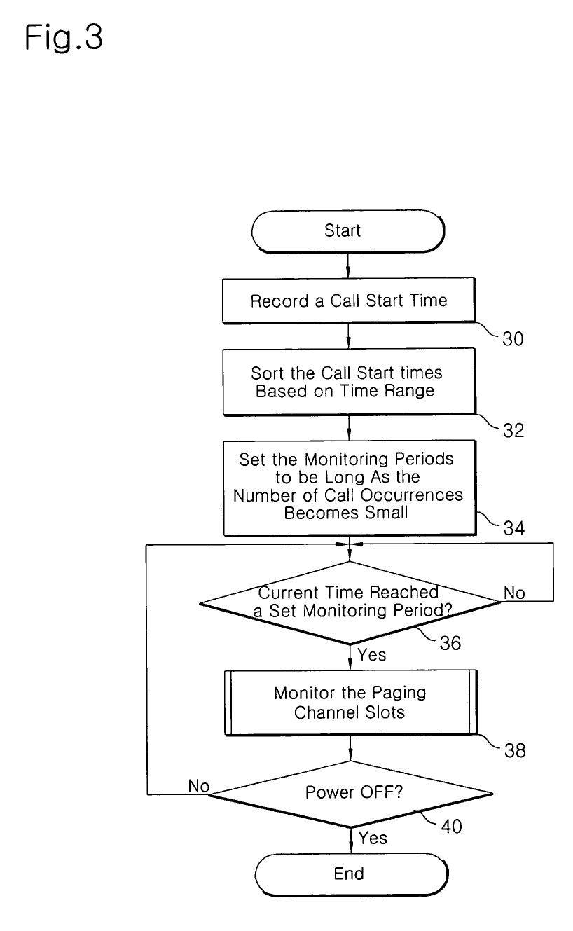

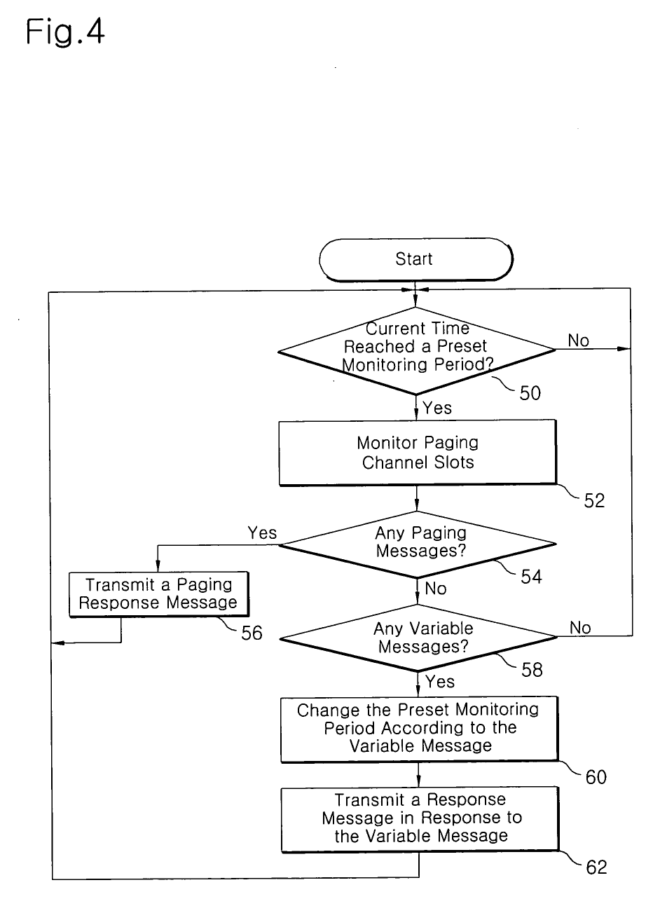

A read-only memory (ROM) 11 is used as a medium for storing control programs for the overall operation of the mobile communication terminal and also for processes shown in FIGS. 3 and 4 to be described below.

A random access memory (RAM) 12 is used as a medium for temporarily storing data created at the time of controlling the mobile communication terminal. An electrically-erasable programmable read-only memory (EEPROM) 13 stores a unique identification number of the mobile communication terminal and data necessary for call processing.

A key input unit 14 includes alphanumeric keys for telephone dialing, function keys, etc. A display unit 15, which is implemented by a liquid crystal display (LCD), displays data necessary for users under the control of the controller 10.

A radio frequency (RF) module 17 is tuned to an RF channel. The RF module 17 amplifies inputted voice signals and converts signals received via an antenna 16 to intermediate frequency (IF) signals. A modem 18 is responsible for modulating/demodulating signals transmitted/received between the controller 10 and the RF module 17.

A power supply 19, including a battery, supplies operating power to each component of the mobile communication terminal. A timer 20 is a device that measures time, which is outputted to the controller 10.

Methods of setting a monitoring period for a paging channel in a mobile communication terminal with the above-mentioned configurations are now set forth.

As a first method, the monitoring period can be set by using the number of calls occurred within each time range as shown in FIG. 3. As a second method, the monitoring periods can be set under the control of a base station as shown in FIG. 4.

The first method will be described with reference to FIG. 3 showing the process of setting a monitoring period for a paging channel.

The controller 10 records a call start time of the mobile communication terminal in a memory each time a call is established in the mobile communication terminal in order to obtain a statistical record of the number of calls occurred within each time range (step 30). The calls include both incoming and outgoing calls. Information on the call start time is obtained from the timer 20. For a more accurate statistical record, the call start times are to be recorded during a predetermined period of time.

Once the call start times are recorded during the predetermined period of time, the controller 10 sorts the call start times based on a time range (step 32). The following Table 1 is an example of the number of calls occurred within each time range.

TABLE 1

| | | Monitoring |
|---|---|---|
| Time range | Number of calls | period |
| : | : | : |
| 12:00-13:00 | 12 | 16-slot |
| | | cycle |
| : | : | : |
| 02:00-03:00 | 0 | 64-slot |
| | | cycle |

As shown in Table 1, after the number of calls occurred within each time range is accumulated for the predetermined period of time, the monitoring periods are set to be long by the controller 10 as the number of call occurrences becomes small (step 34). For instance, the monitoring periods for the paging channel are set so that routines for monitoring the paging channel can be carried out at every 16-slot cycle (1.28 sec) during a time range between 12:00 and 13:00 when there were 12 calls, and at every 64-slot cycle during a time range between 02:00 and 03:00 when there were 0 call. In this case, the monitoring period set for a time range between 01:00 and 02:00 may be determined to be 32-slot cycle.

Upon completion of setting the monitoring periods, the controller 10 determines whether or not a current time has reached a set monitoring period (step 36).

If the current time has reached the set monitoring period, the controller 10 monitors the paging channel slots to determine whether or not any paging messages are present in the paging channel (step 38) and then returns to a main routine. The steps of determining whether or not the current time has reached the set monitoring period and monitoring the paging channel slot are repeated until power-off.

In accordance with the above-mentioned embodiment of the present invention, the number of calls occurred within each time range is automatically accumulated and the monitoring periods for the paging channel are set differently at each time range according to the accumulated results. Accordingly, the paging channel is monitored less frequently in a time range in which the number of call occurrences is small, resulting in reduced battery power consumption.

While the monitoring periods for the paging channel in the above-mentioned embodiment have been set according to the accumulated number of calls occurred within each time range, the monitoring periods for the paging channel can be set differently by employing a day of the week as an additional condition for setting the monitoring period. That is, the monitoring periods based on a time range can be set differently according to a day of the week. For instance, the monitoring periods on Saturdays and Sundays are set to be different from the monitoring periods on weekdays in the same time range.

In addition, the monitoring periods can be varied at regular intervals in a predetermined time range. For example, at every 1 hour time range between 9 am and 6 pm, the monitoring period is set to a 48-slot cycle when the number of call occurrences is 0, the monitoring period is set to a 32-slot cycle when the number of call occurrences is 1 or 2, and the monitoring period is set to a 16-slot cycle when the number of call occurrences is 3 or more.

On the other hand, the above-mentioned embodiment of the present invention can be programmed so as to be operated only in a power save mode.

That is, the controller 10 accumulates the number of call occurrences of the mobile communication terminal based on a time range in a power save mode which is set in response to a user command. The monitoring periods are set to be long by the controller 10 as the number of calls occurred within each time range becomes small. Accordingly, power consumption can be reduced since the paging channel is monitored each time a current time has reached a monitoring period preset in a current time range.

The power save mode can be released in response to the user command. When the power save mode is released, the controller 10 changes the monitoring period to a default value to monitor the paging channel at regular monitoring periods.

A method of setting the monitoring period for the paging channel in accordance with another embodiment of the present invention will be described with reference to FIG. 4. In the method in accordance with another embodiment of the present invention, the monitoring period for the paging channel is variably set according to a message transmitted from a base station. The message, which is transmitted from the base station, to be used for varying the monitoring period for the paging channel in the mobile communication terminal is now referred to as “variable message”. As described below, the variable message, for example, includes code information indicating an increment of 1-step (16-slot) or 2-step (32-slot) in the monitoring period, or indicating a decrement of 1-step (16-slot) or 3-step (48-slot) in the monitoring period.

Referring to FIG. 4, when a current time reaches a preset monitoring period (step 50), the controller 10 monitors paging channel slots (step 52). If any paging message is present in the monitored paging channel (step 54), the controller 10 transmits a paging response message to the base station (step 56) and then returns to step 50. That is, until the paging is replied, steps 50 to 56 are repeated so that the paging response message is transmitted in synchronization with the monitoring period for the paging channel.

Accordingly, when it takes a long time for the base station to receive a paging response message from the mobile communication terminal, the base station determines whether the current monitoring period for the paging channel has been set too long, and then transmits to the mobile communication terminal a variable message to vary the monitoring period for the paging channel.

Upon receiving the variable message (step 58), the controller 10 changes the preset monitoring period according to the code information included in the received variable message (step 60). For example, when the received variable message instructs the controller 10 to decrease the current monitoring period, e.g., a 32-slot cycle, by one step (or 16-slot), the controller 10 changes the monitoring period to a 16-slot cycle.

Subsequently, the mobile communication terminal transmits to the base station a response message indicating that the monitoring period has been appropriately changed in response to the variable message (step 62).

As a result, the controller 10 can monitor the paging channel at the changed monitoring period.

In accordance with the second embodiment of the present invention as described above, the monitoring periods for the paging channel can be set differently by the control of the base station. Accordingly, it is possible to remotely control the monitoring periods to reduce power consumption of the mobile communication terminal.

In accordance with another embodiment of the present invention, the controller 10 itself can automatically change the monitoring periods for the paging channel.

For example, when no call is present during a predetermined time, i.e., when a predetermined idle-state time elapses, the controller 10 automatically changes the monitoring period from 16-slot cycle to 32-slot cycle and monitors the paging channel at every 32-slot cycle. When no call is present during the predetermined time in the monitoring operation based on 32-slot cycle, the controller 10 changes the monitoring period to 48-slot cycle and monitors the paging channel at every 48-slot cycle. Furthermore, when no call is present during the predetermined time in the monitoring operation based on the 48-slot cycle, the controller 10 changes the monitoring period back to the 16-slot cycle as a reference cycle and monitors the paging channel at every 16-slot cycle. That is, when no call is present, the controller 10 automatically and sequentially changes the monitoring periods to the 16-slot, 32-slot, 48-slot cycle and back to 16-slot cycle each time the predetermined time elapses. In this case, a time interval set for varying the monitoring period from 16-slot cycle to 32-slot cycle is preferably longer than a time interval set for varying the monitoring period from 32-slot cycle to 48-slot cycle. In addition, a time interval set for varying the monitoring period from 32-slot cycle to 48-slot cycle is preferably longer than a time interval set for varying the monitoring period from 48-slot cycle to 16-slot cycle. This is because it is important to rapidly respond to incoming calls rather than to reduce battery power consumption.

In case of the above example, when a call is incoming, the mobile communication terminal can set the monitoring period to a 16-slot cycle as a reference cycle and then change the monitoring period according to the time elapsed.

In accordance with the present invention, it is possible to reduce battery power consumption in a mobile communication terminal by automatically counting and accumulating the number of call occurrences in the mobile communication terminal to variably set monitoring periods for a paging channel.

In addition, the present invention provides convenience to a user by making it possible to automatically change the monitoring period without the user's intervention, or alternatively by the control of a base station.

Further, the present invention can also be applied to a quick paging operation.

While the present invention has been described with reference to exemplary embodiments thereof, it will be understood by those skilled in the art that various changes in form and details may be made therein without departing from the scope of the present invention as defined by the following claims.

1. A method of setting a monitoring period for a channel in a mobile communication terminal, the method comprising the steps of:
obtaining a call history;
varying the monitoring period according to the call history; and
monitoring the channel according to the varied monitoring period.

2. The method of claim 1, wherein the monitoring period is a period of monitoring a paging channel.

3. The method of claim 2, wherein the step of obtaining comprises the step of accumulating the number of calls occurred within each time range.

4. The method of claim 2, wherein the step of varying comprises the step of setting the monitoring period for the paging channel to be long as the number of calls occurred within each time range becomes small.

5. A method of setting a monitoring period for a channel, the method comprising the steps of:
transmitting a message indicating a variable monitoring period from a base station to the mobile communication terminal; and
changing an existing monitoring period with a monitoring period included in the message in the mobile communication terminal.

6. The method of claim 5, wherein the monitoring period is a period of monitoring a paging channel.

7. The method of claim 6, wherein the monitoring period is increased or decreased in step units according to the message.

8. The method of claim 6, wherein the variable monitoring period depends on a time it takes to receive a paging response message from the mobile communication terminal.

9. A method of setting a monitoring period for a paging channel, the method comprising the steps of:
accumulating the number of calls occurred within each time range;
setting the monitoring period for the paging channel to be long as the number of calls occurred within each time range becomes small; and
monitoring the paging channel at every monitoring period set for each time range.

10. The method of claim 9, wherein the monitoring periods based on the time range are set differently according to a day of the week.

11. The method of claim 9, wherein the monitoring periods based on the time range are set differently at every predetermined time interval within a preset time range.

12. A method of setting a monitoring period for a paging channel in a mobile communication terminal, the method comprising the steps of:
setting a power save mode in response to a user command;
accumulating the number of calls occurred within each time range in the power save mode;
setting the monitoring period for the paging channel to be long in the power save mode as the number of calls occurred within each time range becomes small; and
monitoring the paging channel in the power save mode at every monitoring period set for each time range.

13. The method of claim 12, further comprising the steps of:
releasing the power save mode in response to a user command; and
setting the monitoring period to a default value.

14. The method of claim 12, wherein the monitoring periods based on the time range are set differently according to a day of the week.

15. The method of claim 12, wherein the monitoring periods based on the time range are set differently at every predetermined time interval within a preset time range.

16. A method of setting a monitoring period for a paging channel in a mobile communication terminal transmitting a paging response message in response to a paging signal, the method comprising the steps of:
receiving a variable message which is used for varying the monitoring period from a base station responding to the transmitted paging response message;
varying a preset monitoring period according to the received variable message;
transmitting to the base station a response message in response to the received variable message; and
monitoring the paging channel in the varied monitoring period.

17. The method of claim 16, wherein the monitoring period is increased or decreased in step units according to code information included in the variable message.

18. A method of setting a monitoring period for a paging channel in a mobile communication terminal, the method comprising the steps of:
measuring idle-state time of the mobile communication terminal;
varying the monitoring period when the measured idle-state time exceeds a preset time length; and
monitoring the paging channel in the varied monitoring period.

19. A method of setting a monitoring period for a paging channel in a mobile communication terminal, the method comprising the steps of:
measuring idle-state time of the mobile communication terminal;
varying the monitoring period each time the measured idle-state time exceeds each of preset time lengths; and
monitoring the paging channel in the varied monitoring period.

20. The method of claim 19, wherein the monitoring period is reset to a default value when the idle-state time exceeds the sum total of the preset time lengths.

21. The method of claim 19, wherein the preset time lengths are set to decrease sequentially.

22. The method of claim 20, wherein the preset time lengths are set to decrease sequentially.
